(19) United States
(12) Patent Application Publication
(10) Pub. No.: US 2020/0363875 A1
(43) Pub. Date: Nov. 19, 2020

(54) INPUT MODULE AND INPUT METHOD THEREOF

(71) Applicant: Primax Electronics Ltd., Taipei (TW)

(72) Inventors: Shi-Jie Zhang, Taipei (TW); Che-Yen Huang, Taipei (TW); Ying-Che Tseng, Taipei (TW); Cheng-Yi Tsai, Taipei (TW)

(21) Appl. No.: 16/549,055

(22) Filed: Aug. 23, 2019

(30) Foreign Application Priority Data
May 17, 2019 (TW) 108117165

(51) Int. Cl. G06F 3/02; G06F 3/023

(52) U.S. Cl. CPC G06F 3/021; G06F 3/0238

(57) ABSTRACT

An input module includes a keyboard device and an application program. The application program is installed in a host device. The application program generates a host message according to a host type of the host device and transmits the host message to the keyboard device. After a key of the keyboard device is depressed, a processing unit of the keyboard device generates a key code corresponding to the host type according to the received host message and transmits the key code to the host device. The present invention further provides an input method for the input module.

### FIELD OF THE INVENTION

The present invention relates to the field of an input device, and more particularly to an input device and an input method thereof.

### BACKGROUND OF THE INVENTION

Generally, the widely-used peripheral input device of a computer system includes for example a mouse device, a keyboard device, a trackball device, or the like. Via the keyboard device, characters or symbols can be directly inputted into the computer system. Consequently, most users and most manufacturers of input devices pay much attention to the development of keyboard devices.

FIG. 1 schematically illustrates the relationship between a conventional keyboard device and a computer host. As shown in FIG. 1, the keyboard device 1 is in communication with the computer host 2. An operating system 21 is installed in the computer host 2. The keyboard device 1 comprises plural keys 11. These keys 11 include for example ordinary keys, numeric keys and functional keys. When one of the keys 11 is depressed by the user, a corresponding key code is issued from the keyboard device 1 to the computer host 2. According to the received key code, the operating system 21 of the computer host 2 executes a function corresponding to the depressed key. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

Especially, the key code set is determined according to the type of the operating system 21. For example, in case that the operating system 21 is a Microsoft operating system (also referred as Microsoft OS), the action of inputting the English letter “A” is performed when the key code “65” is received. Whereas, in case that the operating system 21 is a Macintosh operating system (also referred as Mac OS), the action of inputting the English letter “A” is performed when the key code “1” is received. In other words, even if different operating systems 21 receive the same key code, different input actions are possibly performed.

For solving the above drawbacks, a keyboard device that can be previously set by the user according to the operating system 21 of the computer host 2 has been introduced into the market. For example. The Logitech K780 keyboard device is equipped with a first key code look-up table and a second key code look-up table corresponding to the Microsoft OS and the Mac OS, respectively. If the operating system 21 of the computer host 2 is the Microsoft OS, the user may press and hold the composite key (Fn+P) of the keyboard device 1 for 3 seconds. Consequently, the keyboard device 1 is configured to use the key set corresponding to the first key code look-up table. If the operating system 21 of the computer host 2 is the Mac OS, the user may press and hold the composite key (Fn+O) of the keyboard device 1 for 3 seconds. Consequently, the keyboard device 1 is configured to use the key set corresponding to the second key code look-up table.

As mentioned above, the keyboard device 1 needs to be previously and manually set by the user. Consequently, after any key 11 is depressed, the key code that is accurately recognized by the operating system 21 can be transmitted to the computer host 2 and the operating system 21 executes the accurate input action. Generally, the frequency of changing the operating system 21 of the computer host 2 is very low. If the user wants to change the settings of the keyboard device 1 after the operating system 21 is changed, the user usually forgets which composite key needs to be depressed. In other words, the conventional input module and the conventional input method need to be further improved.

### SUMMARY OF THE INVENTION

The present invention provides an input module. The input module includes a keyboard device and an application module. A host message containing a host type of a host device in the environment is provided from the application program to the keyboard device automatically. After one key of the keyboard device is depressed, a key code that is recognizable by the host device is outputted from the keyboard device. According to the key code, the host device executes the input action accurately.

The present invention also provides an input method for the input module of the present invention.

In accordance with an aspect of the present invention, an input module is provided. The input module includes a keyboard device and an application program. The keyboard device includes plural keys and a processing unit. The application program is installed in a host device. The application program generates a host message according to a host type of the host device and transmits the host message to the keyboard device. After one of the plural keys is depressed, the processing unit generates a key code corresponding to the host type according to the received host message and transmits the key code to the host device.

In accordance with another aspect of the present invention, an input method is provided. The input method includes the following steps. In a step (P1), a host type of a host device in communication with a keyboard device is detected. In a step (P2), a host message is generated according to the host type, and the host message is transmitted to the keyboard device. In a step (P3), the host message is received. After a key of the keyboard device is depressed, a key code corresponding to the host type is generated according to the host message.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the relationship between a conventional keyboard device and a computer host;

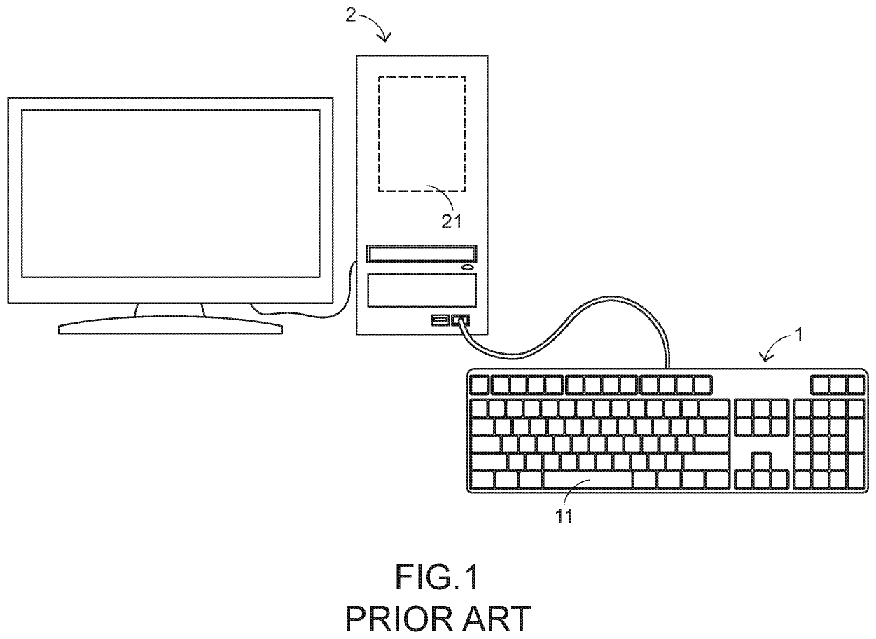

FIG. 2 schematically illustrates the relationship between a host device and an input module according to a first embodiment of the present invention;

FIG. 3 is a schematic functional block diagram illustrating the communication between the host device and the input module as shown in FIG. 2;

FIG. 4 is a flowchart illustrating an input method according to the first embodiment of the present invention;

FIG. 5 is a schematic functional block diagram illustrating the communication between a host device and an input module according to a second embodiment of the present invention; and

FIG. 6 is a flowchart illustrating an input method according to the second embodiment of the present invention.

### DETAILED DESCRIPTION OF THE PREFERRED EMBODIMENT

The embodiments of present invention will be described more specifically with reference to the following drawings. Generally, in the drawings and specifications, identical or similar components are designated by identical numeral references. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

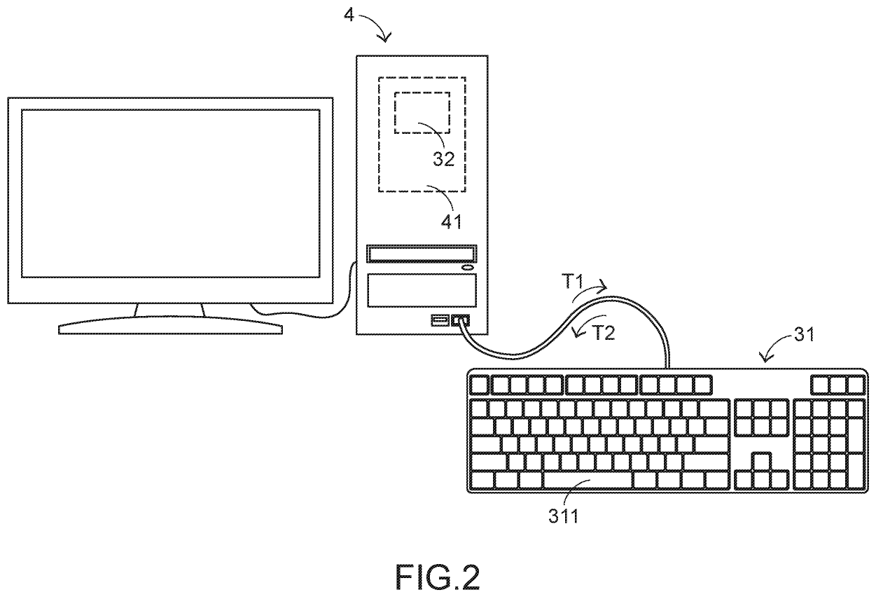

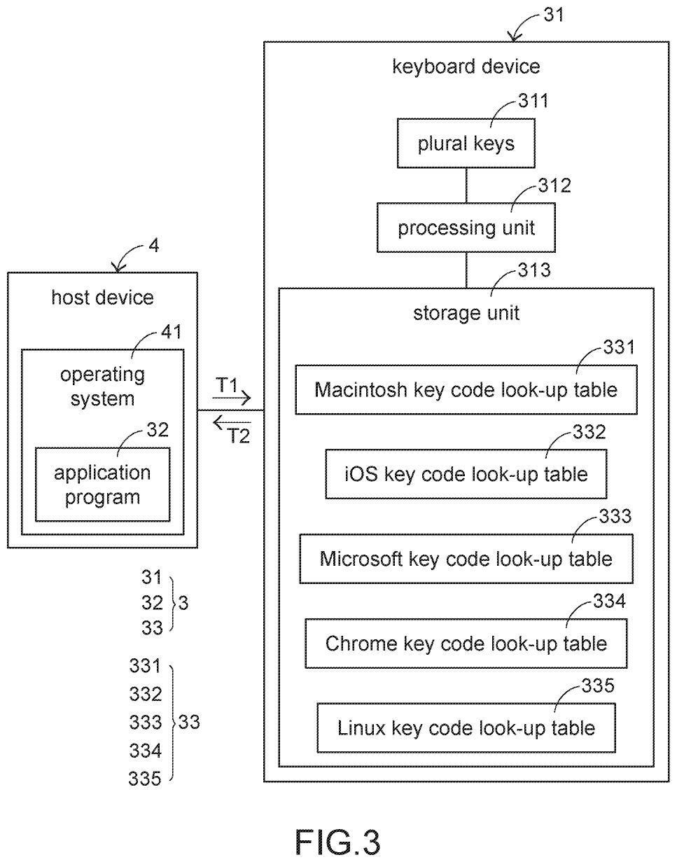

Please refer to FIGS. 2 and 3. FIG. 2 schematically illustrates the relationship between a host device and an input module according to a first embodiment of the present invention. FIG. 3 is a schematic functional block diagram illustrating the communication between the host device and the input module as shown in FIG. 2. The input module 3 comprises a keyboard device 31 and an application program 32. The keyboard device 31 is in communication with the host device 4 in a wired transmission manner. For example, the keyboard device 31 is a universal serial bus keyboard device, and the keyboard device 31 is connected with the host device 4 through a universal serial bus. In another embodiment, the keyboard device 31 is in communication with the host device 4 in a wireless transmission manner. For example, the keyboard device 31 is a Bluetooth keyboard device, and the keyboard device 31 is in communication with the host device 4 through the Bluetooth connection. It is noted that the way of connecting the keyboard device 31 with the host device 4 is not restricted. In the embodiment of FIG. 2, the host device 4 is a desktop computer. The example of the host device 4 is not restricted as long as the host device 4 is an electronic device with computing capacity and an operating system 41 is installed in the electronic device. For example, the electronic device is a mobile communication device or a tablet computer.

The keyboard device 31 comprises keys 311, a processing unit 312 and a storage unit 313. The processing unit 312 is electrically connected between the plural keys 311 and the storage unit 313. These keys 311 include for example ordinary keys, numeric keys and functional keys. The application program 32 of the input module 3 is installed in the host device 4. According to the host type of the host device 4, the application program 32 generates a host message T1 to the keyboard device 31. When one key 311 of the keyboard device 31 is depressed by the user's finger, the processing unit 312 of the keyboard device 31 generates a key code T2 to the host device 4 according to the host message T1 received by the keyboard device 31. The key code T2 is related to the host type. Moreover, the key code T2 can be accurately recognized by the host device 4. According to the received key code T2, the host device 4 executes a corresponding function. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

In an embodiment, the host type of the host device 4 indicates the operating system type. Preferably but not exclusively, the operating system type includes the Macintosh operating system (Mac OS), iOS, the Microsoft operating system (Microsoft OS), Android OS, the Chrome operating system or the Linux operating system. The input module 3 further comprises plural key code look-up tables 33 corresponding to various operating system types. The plural key code look-up tables 33 are stored in the storage unit 313 of the keyboard device 31. For example, these key code look-up tables 33 include a Macintosh key code look-up table 331, an iOS key code look-up table 332, a Microsoft key code look-up table 333, a Chrome key code look-up table 334 and a Linux key code look-up table 335. Each of the key code look-up tables 33 is a table about the relationship between the plural keys 311 and the corresponding key codes. For example, in the Macintosh key code look-up table 331, the keys “A” and “B” are related to the key codes “1” and “11”, respectively. In the Microsoft key code look-up table 333, the keys “A” and “B” are related to the key codes “65” and “66”, respectively. The relationships between the operating system types and the corresponding key code look-up tables are well known to those skilled in the art, and are not redundantly described herein. Moreover, the examples of the operating system types and the corresponding key code look-up tables are not restricted.

The operations of the input module 3 will be described as follows. Firstly, the application program 32 installed in the host device 4 detects the operating system 41 in the environment and acquires the host message T1 containing the operating system type. In addition, the host message T1 is transmitted to the keyboard device 31. After the keyboard device 31 receives the host message T1, the processing unit 312 of the keyboard device 31 selects a corresponding key code look-up table 33 from the storage unit 313 according to the received host message T1. When one key 311 is depressed by the user's finger, the processing unit 312 acquires a key code T2 corresponding to the depressed key 311 according to the selected key code look-up table 33. In addition, the key code T2 is transmitted to the host device 4.

In an example, the host message T1 received by the application program 32 of the keyboard device 31 indicates that the host type is the Macintosh operating system type. According to the host message T1, the processing unit 312 selects the Macintosh key code look-up table 331 from the storage unit 313. Then, if the key “A” is depressed by the user's finger, the processing unit 312 acquires the key code “1” corresponding to the key “A” from the Macintosh key code look-up table 331 and transmits the key code “1” to the host device 4. According to the received key code “1”, the operating system 41 of the host device 4 executes the action of inputting the English letter “A”.

In another example, the host message T1 received by the application program 32 of the keyboard device 31 indicates that the host type is the Microsoft operating system type. According to the host message T1, the processing unit 312 selects the Microsoft key code look-up table 333 from the storage unit 313. Then, if the key “A” is depressed by the user's finger, the processing unit 312 acquires the key code “65” corresponding to the key “A” from the Microsoft key code look-up table 333 and transmits the key code “65” to the host device 4. According to the received key code “65”, the operating system 41 of the host device 4 executes the action of inputting the English letter “A”.

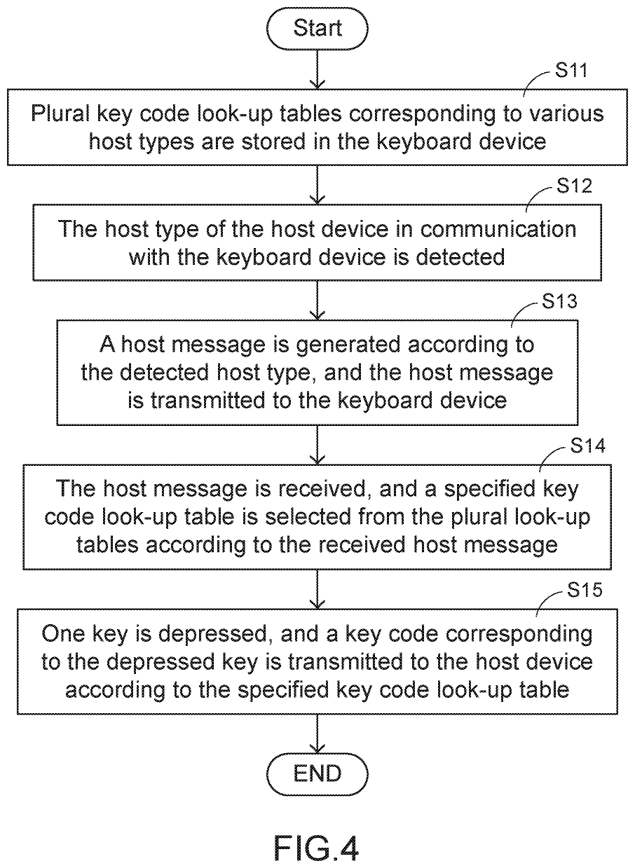

The present invention further provides an input method. FIG. 4 is a flowchart illustrating an input method according to the first embodiment of the present invention. The input method comprises the following steps. In a step S11, plural key code look-up tables corresponding to various host types are stored in the keyboard device. In a step S12, the host type of the host device in communication with the keyboard device is detected. In a step S13, a host message is generated according to the detected host type, and the host message is transmitted to the keyboard device. In a step S14, the host message is received, and a specified key code look-up table is selected from the plural look-up tables according to the received host message. In a step S15, one key is depressed, and a key code corresponding to the depressed key is transmitted to the host device according to the specified key code look-up table.

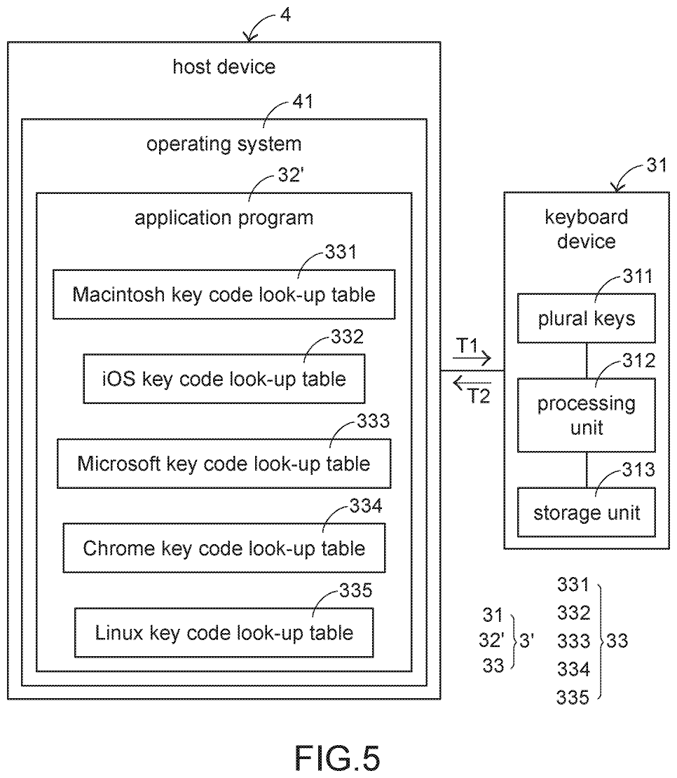

FIG. 5 is a schematic functional block diagram illustrating the communication between a host device and an input module according to a second embodiment of the present invention. The structures and functions of the components of the input module 3′ which are identical to those of the first embodiment are not redundantly described herein. In the first embodiment, plural key code look-up tables 33 corresponding to various operating system types are stored in the storage unit 313 of the keyboard device 31. In the second embodiment, the plural key code look-up tables 33 corresponding to various operating system types are stored in the application program 32′. After the application program 32′ installed in the host device 4 detects the operating system 41 in the environment, the host message T1 containing the operating system type is acquired. Then, the host message T1 and a key code look-up table 33 corresponding to the operating system 41 are transmitted to the keyboard device 31. Then, the specified key code look-up table 33 is stored in the storage unit 313 of the keyboard device 31. When one key 311 is depressed by the user's finger, the processing unit 312 acquires a key code T2 corresponding to the depressed key 311 according to the key code look-up table 33 in the storage unit 313. In addition, the key code T2 is transmitted to the host device 4.

For example, the application program 32′ installed in the host device 4 detects that the operating system 41 in the environment is the Macintosh operating system type. Then, the host message T1 containing the host type (i.e., the Macintosh operating system type) and the Macintosh key code look-up table 331 are transmitted from the application program 32′ to the keyboard device 31. After the Macintosh key code look-up table 331 is received by the keyboard device 31, the Macintosh key code look-up table 331 is stored in the storage unit 313. Then, if the key “A” is depressed by the user's finger, the processing unit 312 acquires the key code “1” corresponding to the key “A” from the Macintosh key code look-up table 331 in the storage unit 313 and transmits the key code “1” to the host device 4. According to the received key code “1”, the operating system 41 of the host device 4 executes the action of inputting the English letter “A”.

For example, the application program 32′ installed in the host device 4 detects that the operating system 41 in the environment is the Microsoft operating system type. Then, the host message T1 containing the host type (i.e., the Microsoft operating system type) and the Microsoft key code look-up table 333 are transmitted from the application program 32′ to the keyboard device 31. After the Microsoft key code look-up table 333 is received by the keyboard device 31, the Microsoft key code look-up table 333 is stored in the storage unit 313. Then, if the key “A” is depressed by the user's finger, the processing unit 312 acquires the key code “65” corresponding to the key “A” from the Microsoft key code look-up table 331 in the storage unit 313 and transmits the key code “65” to the host device 4. According to the received key code “65”, the operating system 41 of the host device 4 executes the action of inputting the English letter “A”.

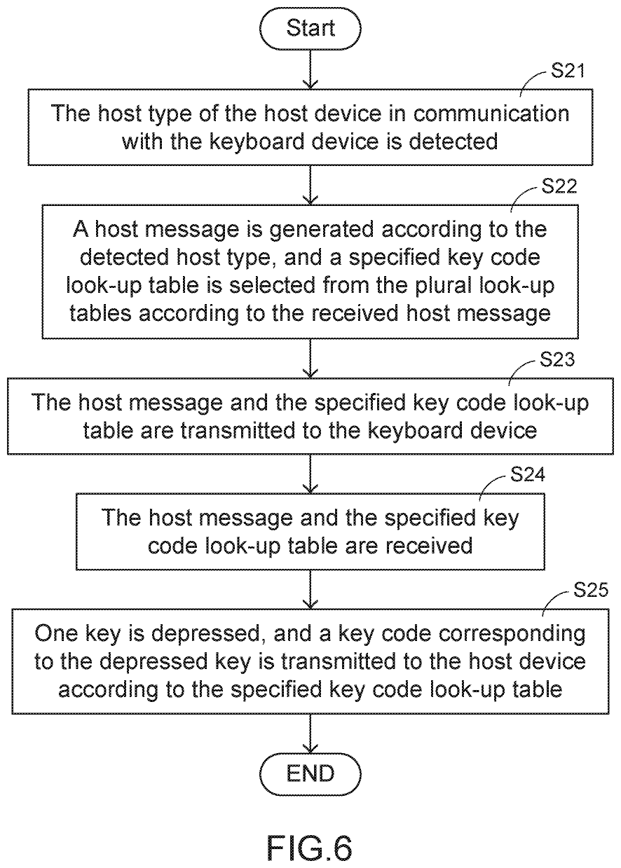

The present invention further provides another input method. FIG. 6 is a flowchart illustrating an input method according to the second embodiment of the present invention. In a step S21, the host type of the host device in communication with the keyboard device is detected. In a step S22, a host message is generated according to the detected host type, and a specified key code look-up table is selected from the plural look-up tables according to the received host message. In a step S23, the host message and the specified key code look-up table are transmitted to the keyboard device. In a step S24, the host message and the specified key code look-up table are received. In a step S25, one key is depressed, and a key code corresponding to the depressed key is transmitted to the host device according to the specified key code look-up table.

From the above descriptions, the input module and the input method of the present invention are applied to the host devices corresponding to various host types. The application program is installed in the host device. When the keyboard device of the input module is in communication with the host device, the host message containing the host type in the environment is provided from the application program to the keyboard device automatically. After one key of the keyboard device is depressed, the key code that is recognizable by the host device is outputted. According to the key code, the host device executes the input action accurately. In other words, the technologies of the present invention are industrially valuable.

In the above embodiments, the host type is the operating system type. It is noted that numerous modifications and alterations may be made while retaining the teachings of the invention. For example, in another embodiment, the host type is the language type such as the Traditional Chinese language type, the Russian language type, the Japanese language type, . . . , and so on. Different language types are related to different key code look-up tables. Similarly, when the keyboard device of the input device is in communication with the host device, the host message containing the language type in the environment is provided from the application program of the host device to the keyboard device automatically. After one key of the keyboard device is depressed, the key code that is recognizable by the host device is outputted. According to the key code, the host device executes the input action accurately.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input module, comprising:
a keyboard device comprising plural keys and a processing unit; and
an application program installed in a host device, wherein the application program generates a host message according to a host type of the host device and transmits the host message to the keyboard device,
wherein after one of the plural keys is depressed, the processing unit generates a key code corresponding to the host type according to the received host message and transmits the key code to the host device.

2. The input module according to claim 1, wherein the host type is an operating system type or a language type.

3. The input module according to claim 2, wherein the operating system type includes a Macintosh operating system (Mac OS), iOS, a Microsoft operating system (Microsoft OS), Android OS, a Chrome operating system or a Linux operating system.

4. The input module according to claim 1, wherein the input module further comprises plural key code look-up tables corresponding to various host types, wherein after the processing unit receives the host message, the processing unit selects a specified key code look-up table from the plural key code look-up tables according to the host message and generates the key code corresponding to the depressed key according to the specified key code look-up table.

5. The input module according to claim 4, wherein the keyboard device further comprises a storage unit, and the plural key code look-up tables are stored in the storage unit.

6. The input module according to claim 4, wherein the plural key code look-up tables are stored in the application program, and the host message and the specified key code look-up table corresponding host message are transmitted from the application program to the keyboard device according to the host type.

7. The input module according to claim 1, wherein the keyboard device is a universal serial bus keyboard device or a Bluetooth keyboard device.

8. The input module according to claim 1, wherein the host device is a mobile communication device, a tablet computer or a desktop computer.

9. An input method, comprising steps of:
(P1) detecting a host type of a host device, which is in communication with a keyboard device;
(P2) generating a host message according to the host type, and transmitting the host message to the keyboard device; and
(P3) receiving the host message, wherein after a key of the keyboard device is depressed, a key code corresponding to the host type is generated according to the host message.

10. The input method according to claim 9, wherein the host type is an operating system type or a language type

11. The input method according to claim 10, wherein the operating system type includes a Macintosh operating system (Mac OS), iOS, a Microsoft operating system (Microsoft OS), Android OS, a Chrome operating system or a Linux operating system.

12. The input method according to claim 9, further comprising a step of selecting a specified key code look-up table from plural key code look-up tables according to the host message, and generating the key code corresponding to the depressed key according to the specified key code look-up table.

13. The input method according to claim 12, further comprising a step of storing the plural key code look-up tables into the keyboard device before the step (P1) is performed.

14. The input method according to claim 12, wherein the step (P3) further comprises a sub-step of receiving the specified key code look-up table.

15. The input method according to claim 9, wherein the keyboard device is a universal serial bus keyboard device or a Bluetooth keyboard device.

16. The input method according to claim 9, wherein the host device is a mobile communication device, a tablet computer or a desktop computer.
